(19) United States
(12) Patent Application Publication
(10) Pub. No.: US 2010/0314843 A1
(43) Pub. Date: Dec. 16, 2010

(54) CHARGING VEHICLE FOR AN AUTOMATIC ASSEMBLY MACHINE FOR PHOTOVOLTAIC MODULES

(75) Inventor: BERNHARD BECK, Volkach OT Dimbach (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Adensis GmbH, Dresden (DE)

(21) Appl. No.: 12/795,980

(22) Filed: Jun. 8, 2010

(30) Foreign Application Priority Data
Jun. 12, 2009 (DE) 10 2009 024 740.8

(51) Int. Cl. B60P 1/02

(52) U.S. Cl. 280/6.151

(57) ABSTRACT

A ground vehicle for feeding photovoltaic modules to an automatic assembly machine is disclosed, wherein the automatic assembly machine is movable on previously installed PV modules and the PV modules that still need to be installed are fed to the automatic assembly machine above a supporting structure. The ground vehicle has six vertically movable rams arranged in spaced-apart relationship in pairs in the direction of travel, with the PV modules to be installed located above the rams. Timing of the vertical ram motion is controlled so that a retracted ram of a ram pair is always extended before the other ram of the ram pair is lowered.

### CROSS-REFERENCES TO RELATED APPLICATIONS

This application claims the priority of German Patent Application, Serial No. 10 2009 024 740.8, filed Jun. 12, 2009, pursuant to 35 U.S.C. 119(a)-(d), the content of which is incorporated herein by reference in its entirety as if fully set forth herein.

### BACKGROUND OF THE INVENTION

The present invention relates to a ground vehicle for transporting an article above an obstacle extending transversely to the travel direction. The ground vehicle is used to charge an automatic assembly machine with photovoltaic (PV) modules, wherein the automatic assembly machine is movable on previously installed photovoltaic modules and the photovoltaic modules that still need to be installed are presented to the automatic assembly machine above a loadbearing structure adapted to receive the photovoltaic modules. The ground vehicle may also be used for other purposes aside from the aforementioned use. For example, articles of any kind, as well as persons located above the supporting structure, may be conveyed.

The following discussion of related art is provided to assist the reader in understanding the advantages of the invention, and is not to be construed as an admission that this related art is prior art to this invention.

Automatic assembly machine of this type are used on construction sites of large photovoltaic installations which typically have a rectangular shape with edge dimensions of several hundred meters. Large installations are presently in the planning stage, in particular in the USA, where supporting structures extend over several kilometers. At this time, the individual photovoltaic modules must be conveyed to the automatic assembly machine by hand, which is expensive when considering the large number of several thousands of PV modules to be installed. The invention differs from the conventional approach where a device feeds an automatic assembly machine located above a supporting structure from below, i.e., through the relatively narrow openings in the assembly structure, with relatively large-format PV modules.

Accordingly, there is a need for an improved ground vehicle to obviate prior art shortcomings and to enable transport of PV modules above the supporting structure, in spite of obstructing cross braces of the supporting structure.

### SUMMARY OF THE INVENTION

The present invention resolves prior art problems encountered in automation of the installation process of photovoltaic modules in large photovoltaic installations by feeding the PV modules to be installed to the automatic assembly machine above the supporting structure.

According to one aspect of the invention, a ground vehicle for transporting an article above an obstacle extending transversely to a direction of travel includes a frame, at least six rams attached to the frame and arranged as spaced-apart pairs in the direction of travel, wherein the rams are vertically movable between an extended position supporting the article and a retracted position, in which the ram is retracted away from the article towards the frame, and a control device configured to extend a first retracted ram of a pair to the extended position before lowering the second ram of the pair to the retracted position. The PV modules to be installed are placed above the frame.

According to one embodiment, the three ram pairs may be arranged in a triangle, so that a stack of PV modules located above the ram is securely supported. This may be accomplished, for example, by employing a support plate having six indentations on its bottom side, with one of the rams engaging with a corresponding indentation when the ram is extended. The top side of the support plate is flat, in particular across an area, and adapted—similar to a palette—to receive a stack of PV modules. Alternatively, the palette itself may be used as support.

Accordingly, the three ram pairs provide at least three support points for the PV modules. Alternatively, eight rams may be employed, which then form four ram pairs and support the support plate, or alternatively the PV modules, near their four corners. According to the invention, the rams are best be described in pairs, in that from a possible plurality of rams, for example four rams for each region of the support, at least two rams operate as a pair in a particular cycle. In the next cycle, two other rams of the four rams may be more advantageously positioned, for example, for compensating for uneven terrain.

In operation, the ground vehicle is oriented from an open end of a passageway between two rows of ground supports of the supporting structure. When the first ram approaches or contacts the first transverse beam (also referred to as modules rail) in the direction of travel, its counterpart located behind of the first ram in the pair is extended, until both rams of the pair make contact with the support plate or the PV modules. The front ram is then retracted so that it fits underneath the transverse beam. The ground vehicle may now be moved by a distance which corresponds to the spacing between the rams of a pair in the direction of the passageway. The first ram slides then underneath the transverse beam and remains lowered until its counterpart contacts the transverse beam. The first ram is then raised until it engages with the notch in the support plate, or until it contacts the bottom side of the stack of the PV modules to be installed. At this time, both rams of the pair again contact the support plate or directly the PV modules. The counterpart (corresponds to the second or rear ram of the ram pair) is then lowered so that it fits underneath the first transverse beam. The ground vehicle is then moved along the passageway until either the following ram contacts the first transverse beam or the first ram pair contacts the next transverse beam or has approached the next transverse beam within a minimum distance. Which of the events occurs earlier depends on the length of the support plate and/or the distance between the notches from one ram pair to the next, and on the distance between the two rams of a pair.

Advantageously, the rams may be extendable to a variable length, so that the support plate is maintained plane-parallel and at a predetermined distance from the area spanned by the transverse beams. This measure makes it possible to use short ram excursions, which reduces the time from actuation of the ram to the time when the ram reaches its end position.

Advantageously, after having traveled underneath a transverse beam, the ram disposed opposite to the travel direction (referred to above as the second ram or the counterpart) may be extended. During normal travel, both rams of a pair always provide support, which aids stability. Moreover, the travel is faster, because when the first ram approaches a transverse beam, this ram may be immediately lowered without having to wait for extension of the rear ram. The ground vehicle needs to stop only when the first ram has passed the transverse beam and the load is transferred (by extension of the first ram that has already passed, and lowering the counterpart ram to prepare for its crossing underneath).

If three or four ram pairs are more advantageous also depends on the geometry of the system. When using three ram pairs, the control is significantly less complex, but the steps for travel require more time, because the ground vehicle must stop again at the center ram pair. This disadvantage is eliminated when the four ram pairs engage on the ends of the system. On the other hand, three ram pairs may be provided, depending on the shape of the PV modules, in particular their length/width ratio, wherein one of the ram pairs is located on the edge midway between two corners, whereas the two other ram pairs are located at the corners of the opposite edge. This alternative embodiment may be tested first, because relatively large displacement steps are feasible with little control complexity.

The time, when a ram reaches a transverse beam, may be detected, for example, with a laser beam that measures the respective distance and supplies the measurement result to the control. The simplest design includes contact sensors responding to contact with a transverse beam. Such contact sensor may be spring-loaded so that it may be lowered again together with the associated ram after making contact. Other conventional approaches may be used, for example a capacitive proximity sensor.

The ground vehicle may be automated so that a travel movement follows each cycle, i.e., each ram extension and the subsequent ram lowering operation, which may be implemented, in particular, with a stepper motor. The advance steps may each have a length between 1 cm and 5 cm.

According to another advantageous embodiment, the indentations may be funnel-shaped and the ends of the ram may be shaped as a truncated cone. This provides sufficient tolerance that the ram hits the notch during extension of the ram. At least one of the parts, ram or protrusion, may be made of an elastic material, such as hard rubber. A mixed shape of a notch made of Teflon and a ram end made of rubber is also feasible.

As indicated above, the supporting structure includes a plurality of ground supports which have one end anchored in the ground. Longitudinal beams are attached to their other free ends. Transverse beams adapted for receiving the PV modules are then installed on the longitudinal beams and secured, for example, with clamps. The ground supports form parallel rows, with a respective passageway provided between each of two parallel rows. The ground vehicle must drive along this passageway. In order to travel substantially in the center between the supports, the ground vehicle is advantageously provided with a centering device which prevents the ground vehicle from approaching too closely or touching the ground supports.

A particular advantage is the low overall height of the ground vehicle, which advantageously may be no higher than 0.5 m to 1.0 m when the rams are retracted. The overall height of the photovoltaic system should be kept as low as possible to reduce wind loading of the photovoltaic system. However, a practical installation requires an acceptable overall height. A low automated ground vehicle, which supports the installation from below, makes it possible to further lower the overall height, without loss of installation comfort.

During operation, two ground vehicles may be provided which each feed the automatic assembly machine from a respective beginning or end of the passageway. This makes optimal use of the automatic assembly machine, because one ground vehicle can be moved out and freshly loaded with modules to be installed, while the other vehicle feeds the automatic assembly machine. A fill level sensor, which measures how many PV modules are still left in the automatic assembly machine, may provide early-on a signal requesting that the other vehicle be sent to the automatic assembly machine.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIGS. 1a and 1b show an embodiment of a conventional supporting structure for photovoltaic modules;

FIGS. 2a to 2d show, in a side view, a ground vehicle according to the present invention in different positions;

FIGS. 3a to 3c show, in a top view, various embodiments of a support plate;

FIG. 4 shows, in a side view, a photovoltaic system with module rails installed at a steep angle; and

FIGS. 5 and 6 show an exemplary embodiment of a supporting structure for large installations.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

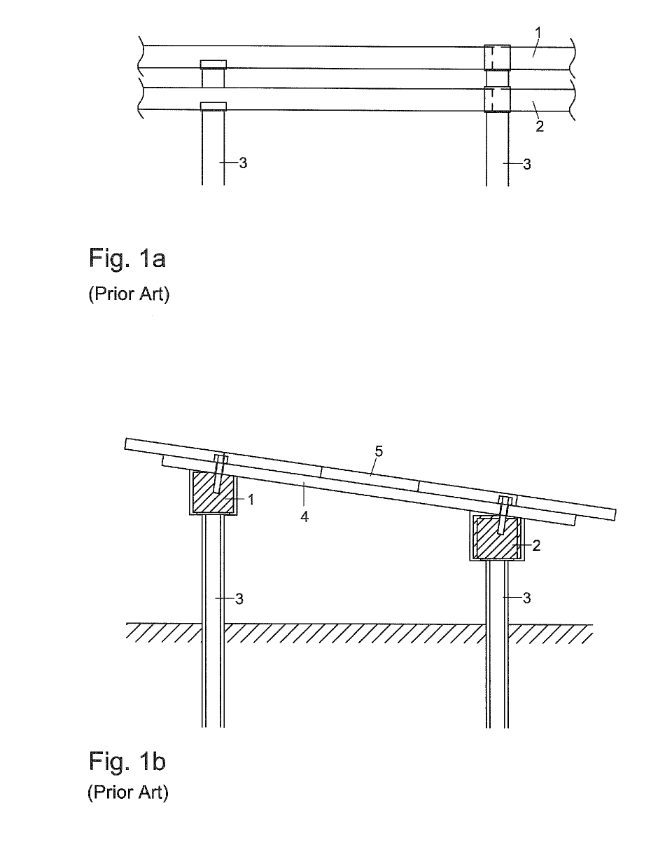

Turning now to the drawing, and in particular to FIGS. 1a and 1b, there are shown two rails or beams 1, 2 which are positioned at slightly different heights. The rails 1, 2 are attached to ground supports 3 which have different lengths commensurate with the different heights of the beams 1, 2. The ground supports are either pile-driven directly into the ground or connected with the ground by a foundation (not shown). The result in both situations is a fixed support for the ground supports 3 at ground level.

FIG. 1b illustrates the transverse beam, i.e., the module rail 4, on which modules 5 receiving solar energy are installed. The module rail 4 may be screwed directly to the two beams 1, 2.

It should be noted that the inclination (if the ground supports 3 are not at the same height) depends on the subsequently described stroke of the rams. The reference symbols 1 to 5 only apply to FIG. 1 showing a conventional embodiment and are replaced in the other figures with different reference symbols.

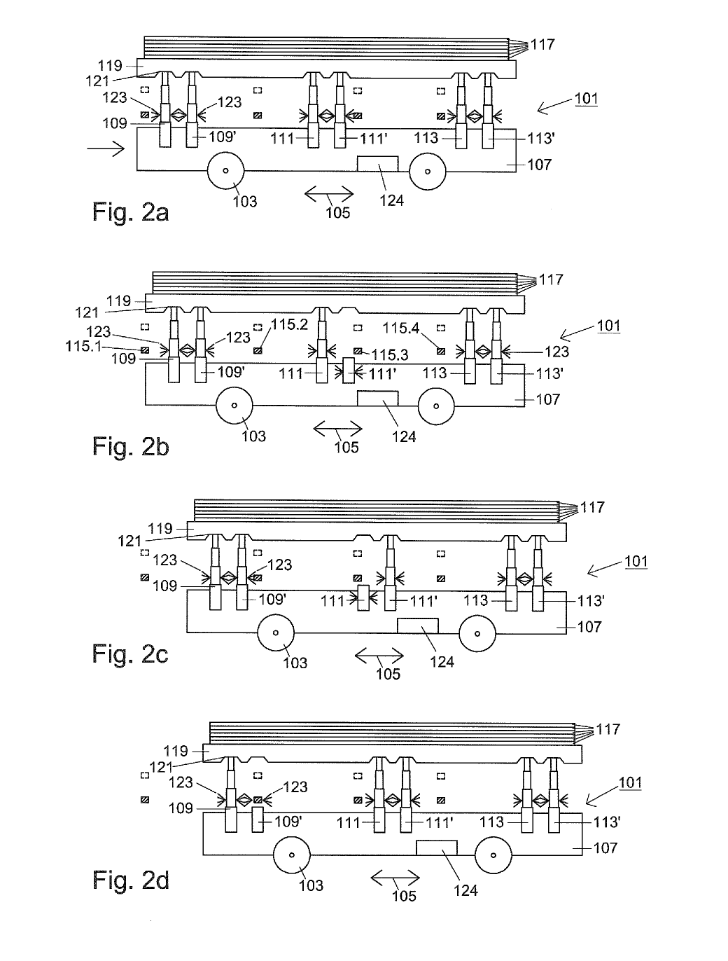

FIGS. 2a to 2d show a ground vehicle 101 in a partially cut side view at different positions along its travel. The ground vehicle 101 moves on wheels 103 along the double arrow 105 indicating the direction of travel. The ground vehicle travels along the double arrow 105 because it must be returned to its initial position after unloading. The ground vehicle 101 includes a frame on which three pairs of rams with the rams 109-109′, 111-111′ and 113-113′ are mounted. The rams 109-109′, 111-111′ and 113-113′ are preferably hydraulic rams having an extension stroke of between 10 cm and 30 cm. The shorter the stroke, the more quickly the lowering and extension operation can be concluded.

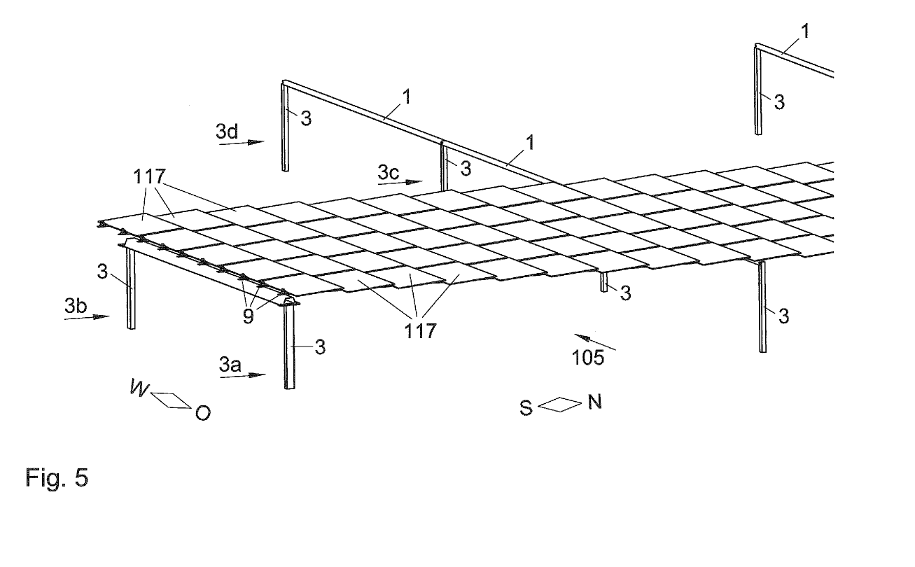

FIGS. 2a to 2d further show four transverse beams or module rails 115₁ to 115₄ which form an obstacle for unobstructed travel of the ground vehicle 101 and correspond to the (conventional) module rails 4 illustrated in FIG. 1. The upper part indicated with broken lines symbolizes the higher section of the module rails 115 which are inclined. The photovoltaic modules are typically installed on the module rails 115 with clamps (not shown). An automatic assembly machine 131 (see FIG. 5) automatically moves on the already installed PV modules by way of suction cups. Photovoltaic modules 117 are fed by the ground vehicle 101 to the automatic assembly machine 131 above the transverse beams 115₁ to 115₄ for installation. The photovoltaic modules 117 are stacked on the top side of a support plate 119. The stack may be secured against shifting by unillustrated lateral retaining elements. The support plate 119 has on the bottom side six indentations or notches 121, which form a funnel-shaped access for the rams 109-109′, 111-111′ and 113-113′. Each ram 109-109′, 111-111′ and 113-113′ is associated with a corresponding notch 121.

FIG. 2a shows a position of the ground vehicle 101, where all rams 109-109′, 111-111′ and 113-113′ are extended and the ground vehicle moves to the right, until one of the front rams 109′, 111′ or 113′ moves into proximity of the transverse beam 115₃. This is in the illustrated exemplary embodiment the front ram 111′ of the center ram pair 111-111′. The critical proximity is measured by proximity sensors 123 which are symbolically indicated on the rams by a ray bundle. The critical proximity may set to a position which gives the ground vehicle 101 sufficient time in forward travel to lower the ram 111′, so that the ground vehicle 101 is able to pass the transverse beam 115₃ without stopping. The critical proximity, however, may also be actual contact with the transverse beam 111′, at which point the ground vehicle 101 stops, lowers the ram 111′ and then accelerates again to pass underneath. The signals from the proximity sensors 123 are supplied to a time control 124 which operates so that a retracted ram of a pair 109, 111, 113 is always extended first, before the other ram 109′, 111′, 113′ of the pair is lowered. The time control 124 includes a control device (not shown) which controls the propulsion of the ground vehicle 101. The control is configured so that always only one movement is possible, when at least one ram of each pair 109, 111, 113 makes contact with the bottom side of the support 119 and at the same time none of rams 109, 109′, 111, 111, 113, 113′, 209, 209′, 211, 211′, 213, 213′, 309, 309′, 311, 311′, 313, 313′, and 315, 315′ is positioned directly in front of one of the transverse beams 115.

In FIG. 2c, the ground vehicle 101 has advanced to a location where the front ram 111′ of the center ram pair 111, 111′ could be extended again for supporting the support plate 119, while now of the rear ram 111 was lowered to enable the ground vehicle 101 to advance further.

FIG. 2d shows another subsequent position, where both rams 111, 111′ of the center ram pair 111, 111′ are again extended, and the front ram 109′ of the rear ram pair 109, 109′ passes underneath the transverse beam 115₂.

During operation of the ground vehicle, a time in the order of seconds is required for extension and retraction of each of the rams 109-109′, 111-111′ and 113-113′, allowing the ground vehicle 101 to advance fast enough so as to always arrive at the next installation location for the next PV module 117 ahead of the automatic assembly machine. The advance is also fast, because the ground vehicle 101 initiates acceleration immediately after each ram cycle of a ram pair. Advantageously, the ground vehicle 101 advances in several small steps of 1 cm to 5 cm is so as to be able to stop in time in front of a ram 109-109′, 111-111′ and 113-113′, when the ground is uneven.

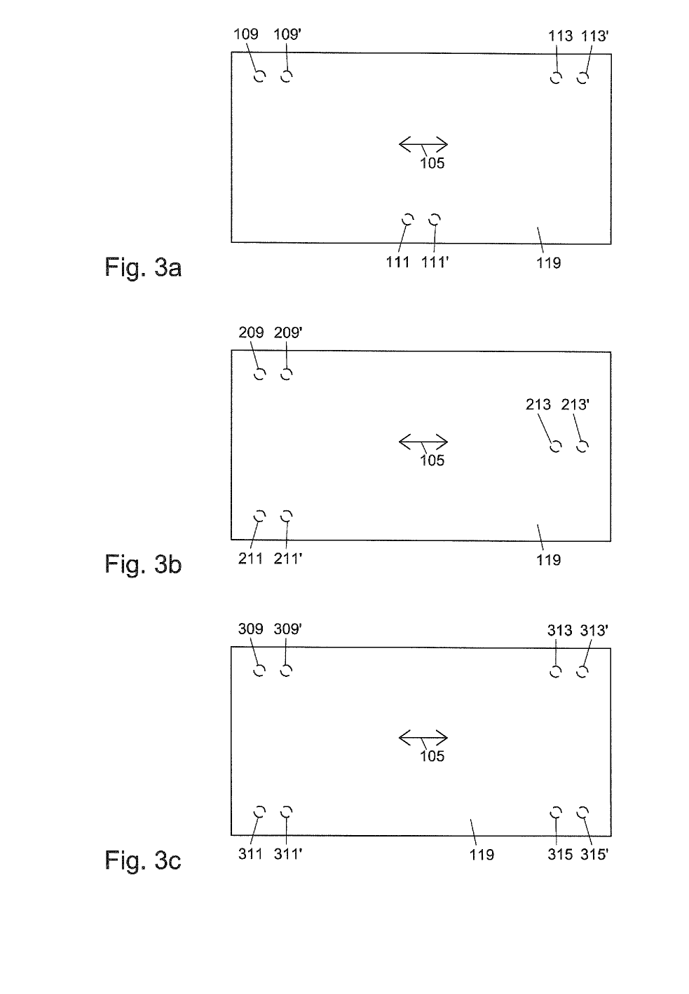

FIGS. 3a to 3c shows each a support 119 with the locations provided for receiving the rams 109-109′, 111-111′ and 113-113′. FIG. 3a shows the support used in FIG. 2 with three ram pairs 109-109′, 111-111′ and 113-113′ at different heights. FIG. 3b shows a variant with three ram pairs 209-209′, 211-211′ and 213-213′, wherein the two ram pairs 209-209′, 211-211′ are arranged at the same height relative to the travel path. This embodiment is somewhat less stable than the previous embodiment, both of us advantages in the control and the travel speed. If the ground vehicle 101 moves exactly in a straight line, the ram pairs 209-209′, 211-211′ arrive always at the same time at the same transverse beam 115, so that they may be commonly actuated. FIG. 3c shows an alternative embodiment with four ram pairs 309-309′, 311-311′, on one hand, and 313-313′ and 315-315′, on the other hand, may be commonly actuated. This embodiment also provides good stability for the support with the stack of photovoltaic modules.

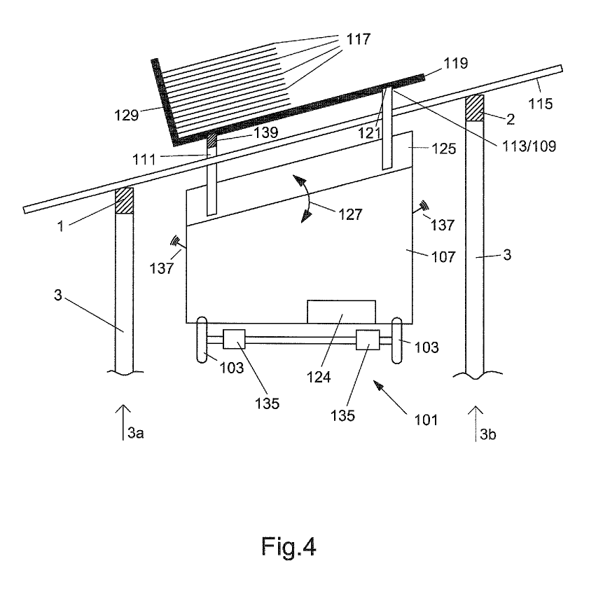

FIG. 4 shows the photovoltaic system in a side view, with the module rails 115 installed at a steeper angle than in the previous example. The vehicle 101 travels perpendicular to the drawing plane and is modified with respect to the aforedescribed vehicle 101 in that the frame 107, on which also the ram pairs 109 to 113 are attached, has a mounting plate 125 with an adjustable inclination for support of the ram pairs 109, 111, 113. The inclination is adjusted by rotating the mounting plate 125 along the curved double arrow 127 and subsequent latching. The inclination corresponds after adjustment essentially to the existing inclination of the module rails 115. The inclination of the attachments of the ram pairs 109 to 113 must also be adjustable relative to the mounting plate 125 via suitable mechanical adjusting means to enable vertical extension and retraction of the rams 109 to 111′ across the entire anticipated range of the adjustment of the inclination of the mounting plate 125. As indicated in FIG. 4, the ground vehicle 101 is propelled by two motors 12, in particular stepper motors. If the direction must be corrected, then a current pulse is only applied to one of the two motors 135, which causes a rotation of the ground vehicle. The travel direction is identified with a centering device having two antennae 137, which emit and receive physical waves to thereby adjust their distance to the rows 3a, 3b. The distance need not be located centrally between the rows 3a, 3b, and the ground vehicle may also be centered along an asymmetric tsupport plate.

Also indicated in FIG. 4 is a weight sensor 139 which is attached at the head end of at least one of the rams on at least one ram pair 109, 111, 113. Measuring the weight makes it possible to record the remaining quantity of stored photovoltaic modules 117 and to initiate, if the quantity drops below a minimum number, a measure such as preparation of an additional support plate 119 with modules 117 or they are transported from eight storage facility.

The support plate 119 is further modified and includes a sidewall 129 which is angled perpendicular from the base surface of the support plate 119, extending at least along the lower edge of the support plate 119. The sidewall 129 prevents the photovoltaic modules from sliding off the support plate 119. The notches 121 hereby prevent the support plate 119 from sliding from the ends of the extended rams.

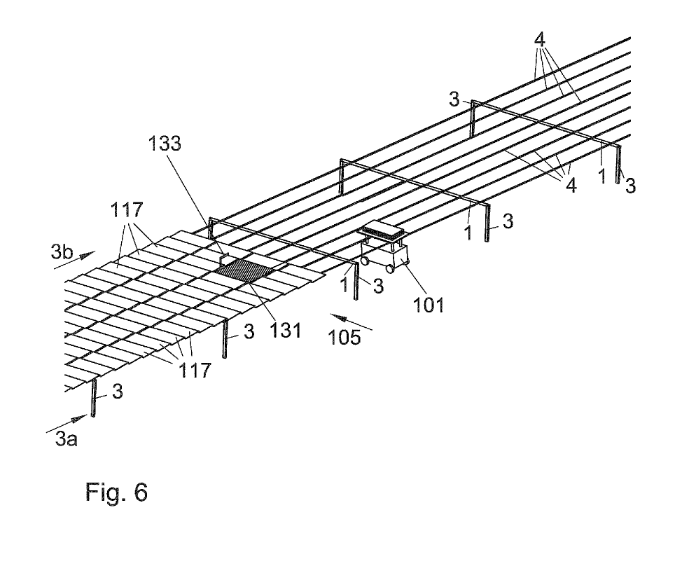

FIGS. 5 and 6 show a large stand for mounting photovoltaic modules 117. FIG. 5 shows a detail of a photovoltaic system, which includes four rows 3a to 3d of ground supports 3 indicated by an arrow. A corresponding beam 1 is installed between one ground support 3 and the next ground support 3, wherein each row 3a to 3d is contiguously provided with a transverse rail 4, similar to a model railroad. Alternatively, beams 1 may be provided which span more than the distance between two ground supports 3, so that a joint is not located on every ground support 3. For example, the correspondingly longer beams 1 may abut only at every second or third ground support 3. As illustrated in FIG. 5, eight module rails 4 oriented in North-South direction are provided, which in the illustrated example received four adjacent PV modules 117.

FIG. 6 shows a strip of the described PV open-space facility, showing two rows 3a to 3b with consecutively arranged ground supports 3. The eight module rails 4 disposed next to one another are implemented as a flat steel band which is placed continuously across all beams 1. The length of the module rail 4 implemented as the flat steel band is only limited by the ease with which the spool on which the steel tape is delivered can be handled. FIG. 6 shows the automatic assembly machine 131 with a gripper arm 133, with the automatic assembly machine 131 traveling on the installed photovoltaic modules 117 and being configured to lift with its gripper arm 133 not yet installed photovoltaic modules 117 from the support plate 119.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A ground vehicle for transporting an article above an obstacle extending transversely to a direction of travel, comprising:
a frame;
at least six rams attached to the frame and arranged as spaced-apart pairs in the direction of travel, wherein the rams are vertically movable between an extended position supporting the article and a retracted position, in which the ram is retracted away from the article towards the frame; and
a control device configured to extend a first retracted ram of a pair to the extended position before lowering the second ram of the pair to the retracted position.

2. The ground vehicle of claim 1, wherein the article comprises photovoltaic modules and the obstacle is a part of a supporting structure for the photovoltaic modules, wherein the ground vehicle is configured to feed photovoltaic modules that still need to be installed to an automatic assembly machine which is movable above photovoltaic modules previously installed above the part of the supporting structure.

3. The ground vehicle of claim 2, further comprising a support plate having a bottom side with six notches configured to engage with an end of at least one of the rams of a pair in an extended position, said support plate carrying the photovoltaic modules that still need to be installed.

4. The ground vehicle of claim 3, wherein each ram comprises a proximity sensor or a contact sensor which is triggered depending on a distance of the ram from a transverse beam of the supporting structure, wherein a signal from the proximity sensor or contact sensor causes the control device to extend the first retracted ram of a pair to the extended position and lower the second ram of the pair to the retracted position.

5. The ground vehicle of claim 4, wherein the rams are extendible to assume different lengths, thereby maintaining the support plate at a predetermined distance from and plane-parallel to a surface spanned by transverse beams of the supporting structure for the photovoltaic modules.

6. The ground vehicle of claim 4, wherein the rams of a ram pair are extended and lowered in a cycle, with each cycle initiating a travel movement of the ground vehicle.

7. The ground vehicle of claim 6, further comprising a stepper motor configured to extend and lower the rams, wherein the resulting travel movement has a predetermined step size with a length of 1 cm to 5 cm.

8. The ground vehicle of claim 3, wherein the notches are funnel-shaped and the end of the at least one ram has a shape of a truncated cone.

9. The ground vehicle of claim 2, wherein the supporting structure for the photovoltaic modules comprises parallel rows of ground supports, and wherein the ground vehicle is configured for operation between two respective parallel rows, the ground vehicle comprising a centering device which maintains a travel path of the ground vehicle substantially midway between the parallel rows.

10. The ground vehicle of claim 1, wherein the ground vehicle has an overall height of between 0.5 m and 1.0 m when the rams are in the retracted position.

11. The ground vehicle of claim 1, wherein the rams have a stroke between the extended position and the retracted position of between 10 cm and 30 cm.

12. The ground vehicle of claim 2, wherein the ground vehicle further comprises a sensor which measures a quantity of the photovoltaic modules that still need to be installed or indicates when the last photovoltaic module has been removed, or both.

13. The ground vehicle of claim 2, wherein two ground vehicles are provided which feed the automatic assembly machine from opposite sides of the supporting structure.
